(19) United States
(12) Patent Application Publication
(10) Pub. No.: US 2014/0250953 A1
(43) Pub. Date: Sep. 11, 2014

(54) SAFETY KIT FOR REALTORS

(71) Applicant: Joy Lynn Briggs, West Des Moines, IA (US)

(72) Inventor: Joy Lynn Briggs, West Des Moines, IA (US)

(21) Appl. No.: 14/198,828

(22) Filed: Mar. 6, 2014

Related U.S. Application Data
(60) Provisional application No. 61/773,423, filed on Mar. 6, 2013.

(51) Int. Cl. E05B 47/00

(52) U.S. Cl. CPC E05B 47/00
USPC 70/14

(57) ABSTRACT

Systems, apparatuses, and kits pertaining to safety are disclosed. A system of the present invention may include a locking device configured to allow access to a property and an unlocking device configured to unlock the locking device. At least one of the locking and unlocking device are configured to activate a safety device, such as a camera, preferably upon unlocking. An apparatus of the present invention may include a processor and a machine-readable medium storing a set of instructions which cause the processor to unlock a locking device and activate a safety device. A kit of the present invention may include a locking device, a camera, an unlocking device, a processor, and a machine-readable medium that causes the processor to activate the camera to begin recording a feed. Other safety devices may include audio recorders, lights, sirens, and apparatuses configured to place an emergency call.

This application claims priority from U.S. Provisional Application Ser. No. 61/773,423, filed Mar. 6, 2013, entitled SAFETY KIT FOR REALTORS, the contents of which is hereby incorporated in its entirety by reference.

### FIELD OF THE INVENTION

### Background

The present invention relates generally to systems and kits for safety and surveillance and more specifically relates to systems and kits for real estate professional safety.

Real estate professionals have increasingly become targets of crime and violence. One study revealed an average of seventy-five deaths per year from 2003-2009 in the real estate and rental and leasing industries. The average Realtor is a 56 year old woman. By the very nature of the occupation, professionals must advertise homes for sale, including scheduling open houses and showings in otherwise vacant properties. Oftentimes, professionals work alone, meeting clients at showings or hosting an open house alone. The trend of violence against real estate professionals has prompted the National Association of Realtors to provide safety materials to members and even sponsor a safety month each year. Safety tips are aimed at private showings, public and private open houses, and the car as professionals drive clients to and from various properties.

Safety tips may include meeting new clients at the office, requiring all new clients to provide identifying information, establishing a buddy system, following clients through houses rather than leading, and using mobile phone applications that can easily contact emergency personnel. However, real estate professionals still must often show properties, which are often vacant, making them opportune targets for violence. Moreover, properties that have been shown via private showings or open houses may be at risk for future crimes. For example, an individual may view a property during an open house to plan a future crime. Accordingly, there is a need for systems and kits to further enhance the safety of real estate professionals and properties in the process of being sold or leased.

### SUMMARY

The present invention provides a system, which may be used to increase the safety of real estate professionals. A system of the present invention includes a locking device and an unlocking device. The locking device is configured to allow access to a property, while the unlocking device is configured to unlock the locking device. Moreover, at least one of the locking and unlocking devices is configured to activate at least one safety device. In some embodiments, the activation of the at least one safety device occurs during the unlocking of the locking device. Unlocking devices may include, but are not limited to, a remote control, mobile application and a key. Moreover, the at least one safety device may include, but is not limited to, a camera, an audio recorder, a light, a siren, and an apparatus to make an emergency call.

Also provided in the present invention is an apparatus having a processor and a machine-readable medium. The machine-readable medium stores a set of instructions that, when executed by the processor, cause the processor to execute operations including unlocking a locking device and activating at least one safety device. A safety device activated by an apparatus of the present invention may include, but is not limited to, a camera, an audio recorder, a light, a siren, and an apparatus to make an emergency call.

The present invention further provides a kit including a locking device, a camera, an unlocking device, a processor, and a machine-readable medium. The locking device is configured to allow access to a property. In addition, the camera is configured to record a feed, which in some embodiments may be stored on a storage device. The machine-readable medium stores a set of instructions that, when executed by the processor, cause the processor to execute operations including activating the camera to begin recording the feed and sending a panic signal. In some embodiments, the processor and machine-readable medium may be located in the locking device. In other embodiments, the processor and machine-readable medium may be located in the unlocking device and the operations executed by the processor may further include unlocking the locking device. Moreover, in some embodiments of the present invention, the operations executed by the processor may include activating a light, activating a siren, sending or receiving a global positioning system signal, and/or sending a signal to emergency personnel, such as by calling 911. A kit of the present invention may further include a sign including a light and/or a siren, one or both of which may be activated by said processor. In addition, a kit of the present invention may include a name badge, which includes a second camera that is activated by the processor.

### BRIEF DESCRIPTION OF THE DRAWINGS

FIG. 1 is a schematic of a system including a locking device, unlocking device, safety device, and a network according to one or more examples of embodiments of the present invention.

FIG. 2 is a perspective view of an apparatus according to one or more examples of embodiments of the present invention.

FIG. 3 is a perspective view of a locking device and an unlocking device according to one or more examples of embodiments of the present invention.

FIG. 4 is an elevational view of a badge and camera according to one or more examples of embodiments of the present invention.

FIG. 5 is an elevational view of a “For Sale” sign with light and siren according to one or more examples of embodiments of the present invention.

### DETAILED DESCRIPTION

The following is a detailed description of embodiments of a system 100, apparatus 200, and kit 300 of the present invention. One particular use of a system 100, apparatus 200, and/or kit 300 of the present invention is to increase the safety of a real estate professional. For ease of discussion and understanding, the following detailed description will refer to the aforementioned real estate embodiment of the present invention. However, it will be appreciated by one skilled in the art that a system 100, apparatus 200, and/or kit 300 of the present invention may be used in any of a number of circumstances, including, but not limited to, rental and leasing professionals or others who unlock and access properties.

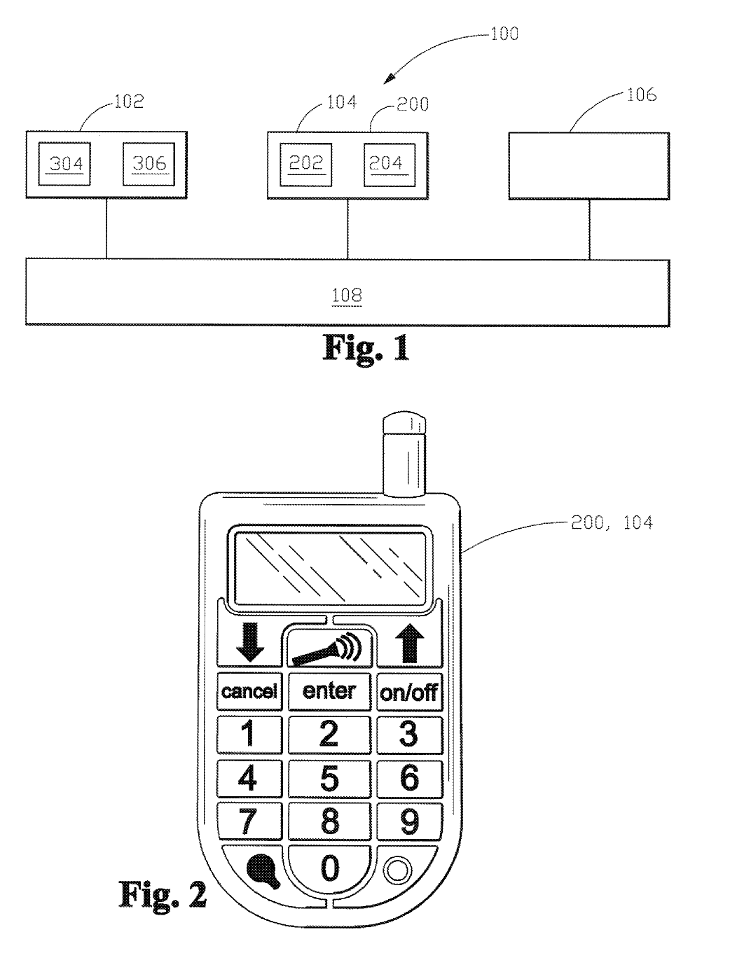

Referring to FIG. 1, a system 100 of a preferred embodiment of the present invention is illustrated. The system 100 includes a locking device 102, an unlocking device 104, and at least one safety device 106. In the illustrated embodiment, the locking device 102, unlocking device 104, and safety device 106 are connected via a network 108. The network may be any type of network known now or in the future, including, but not limited to, a wired network or a wireless network. Wireless communication may be by radio, Bluetooth, wifi, or cellular networking, but is not limited to same. Other embodiments of a system 100 of the present invention need not include a network 108. In those embodiments, one or more of the locking device 102, unlocking device 104, and safety device 106 may be directly connected to one another.

A locking device 102 of the present invention may be of any type known now or in the future. However, in the preferred embodiment, the locking device 102 is the same as or similar to locking devices 102 used by real estate professionals to enclose a key to a property to be accessed. In some embodiments, locking devices 102 already known may be used in a system 100 of the present invention. In other embodiments, locking devices 102 including components to activate a safety device may be used, which will be discussed in further detail below. Similarly, an unlocking device 104 of the present invention may be of any type known now or in the future, including but not limited to a remote control or a key. In the preferred embodiment of the invention, a remote control which is configured to unlock a locking device to provide access to a property is used. The remote control is similar to those currently used by real estate professionals to access a locking device 102, but also is configured to activate at least one safety device 106.

Accordingly, at least one of the locking device 102 and unlocking device 104 is configured to activate at least one safety device 106. As discussed above, in some embodiments, the locking device 102 may be configured to activate the safety device 106, and in other embodiments, the unlocking device 104 may be configured to activate the safety device 106. The safety device 106 may include, but is not limited to a camera, an audio recorder, a light, a siren, and an apparatus to make an emergency call.

In the preferred embodiment of the present invention, activation of the safety device 106 takes place when the locking device 102 is unlocked by the unlocking device 104. Accordingly, either or both of the locking device 102 and the unlocking device 104 may be configured to activate the safety device 106 when the real estate professional arrives at the property for a showing or open house. Moreover, the system 100 may further be configured to deactivate the safety device 106 upon exiting the property and/or relocking the locking device 102. In other embodiments, the safety device 106 may be configured to remain activated for a certain period of time following the initial activation. In the preferred embodiment, the safety device 106 is a camera. However, it is anticipated that many types of safety devices may be employed, as well as any number of safety devices, without departing from the scope of the invention.

It is anticipated that the real estate professional will arrange the camera so as to capture all parties entering the property. Moreover, in some embodiments of the present invention, the feed from the camera may be transmitted to a storage device, such as a cloud computing system, to be saved for future reference or in case of an emergency. Although one goal of a system 100 of the present invention is to increase the safety of real estate professionals, there are other benefits as well. Sometimes, third parties may gain access to a property to return to commit a later crime or act of violence that does not involve the real estate professional. Accordingly, a system 100 of the present invention may prevent future crimes and/or acts of violence from occurring. Having stored video of parties who have entered the home may prevent future crimes and may assist in locating a criminal. To that end, it is anticipated that those employing a system 100 of the present invention will somehow alert others that the property is under surveillance, such as by signs, decals, or word of mouth. This is a benefit to a current or prospective property owner. Further, the current property owner may benefit from viewing videos of showings and/or open houses to learn the feedback of others viewing the home.

In another embodiment of the present invention, an apparatus 200 is provided. The apparatus 200 includes a processor 202 and a machine-readable medium 204. The machine-readable medium stores a set of instructions that, when executed by the processor, cause the processor to execute operations including unlocking a locking device 102 and activating at least one safety device 106. A safety device 106 activated by an apparatus 200 of the present invention may include, but is not limited to, a camera, an audio recorder, a light, a siren, and an apparatus to make an emergency call. In a preferred embodiment of the system 100 of the present invention, the apparatus 200 is an unlocking device 104. As can be seen in FIG. 1, the apparatus 200 includes the processor 202 and machine-readable medium 204 discussed above. An apparatus 200 of the present invention may both unlock the locking device 102 and activate the safety device 106 simultaneously, such as in the case of a camera. However, in other embodiments, the apparatus 200 may unlock the locking device 102 and activate the safety device 106 at different times, such as in the case of making an emergency call. Moreover, the activation may be automatic or require initiation by a user.

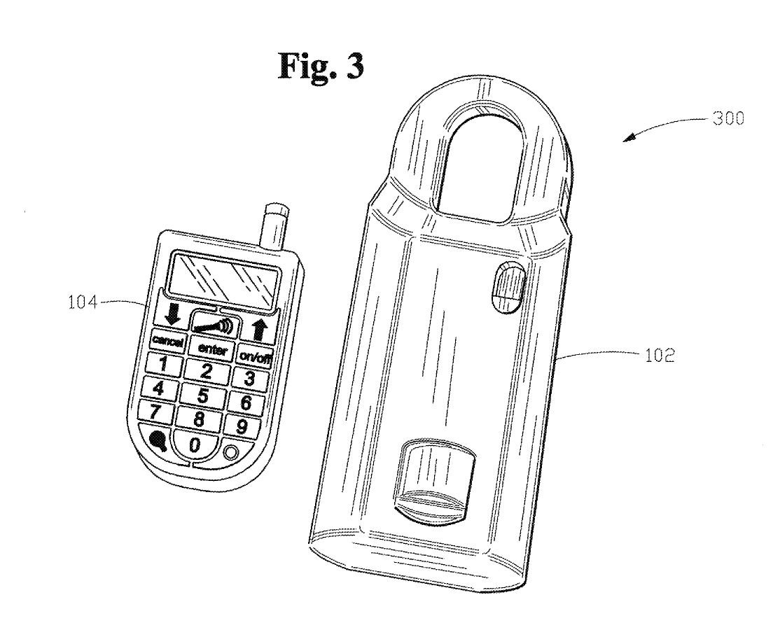

Referring to FIG. 2, an embodiment of an apparatus 200 of the present invention is shown. In the illustrated embodiment, the apparatus 200 is a remote control. However, it will be appreciated by one skilled in the art that an apparatus 200 of the present invention may be many forms, such as a key, mobile phone, or any other type of device known now or in the future. In the preferred embodiment of an apparatus 200 of the present invention, the remote control communicates wirelessly with the locking device 104 of the present invention. Any wireless interface known now or in the future may be used, such as radio, Bluetooth, wifi, or a cellular network. The apparatus 200 may be configured to further communicate with other devices. In one embodiment, the apparatus 200 may wirelessly activate a light or siren located outside a property. In some embodiments, the light and/or siren may be located on a “For Sale” sign located outside of the property. Moreover, the apparatus 200 may be programmed to contact emergency personnel, such as by calling 911 in the event of an emergency.

In another embodiment of the present invention, a kit 300 is provided. A kit of the present invention includes a locking device 102 configured to allow access to a property, a camera configured to record a feed, an unlocking device 104, a processor 202 or 304, and a machine-readable medium 204 or 306. The machine-readable medium 204 or 306 stores a set of instructions that, when executed by the processor 202 or 304 cause the processor 202 or 304 to execute operations including activating the camera to begin recording the feed.

In some embodiments, the processor 304 and machine-readable medium 306 are located in the locking device 102. More preferably, however, the processor 202 and machine-readable medium 204 are located in the unlocking device 104. In the latter embodiment, the operations executed by the processor 202 may further include unlocking the locking device 102. Moreover, in either embodiment, the operations may include activating another safety device 106, including a light, a siren, or a panic signal. A panic signal may include sending a signal to emergency personnel, such as by dialing 911. In other embodiments, the panic signal may call another phone number or activate the aforementioned lights and or sirens. In addition, the operations may include sending or receiving a global positioning system signal.

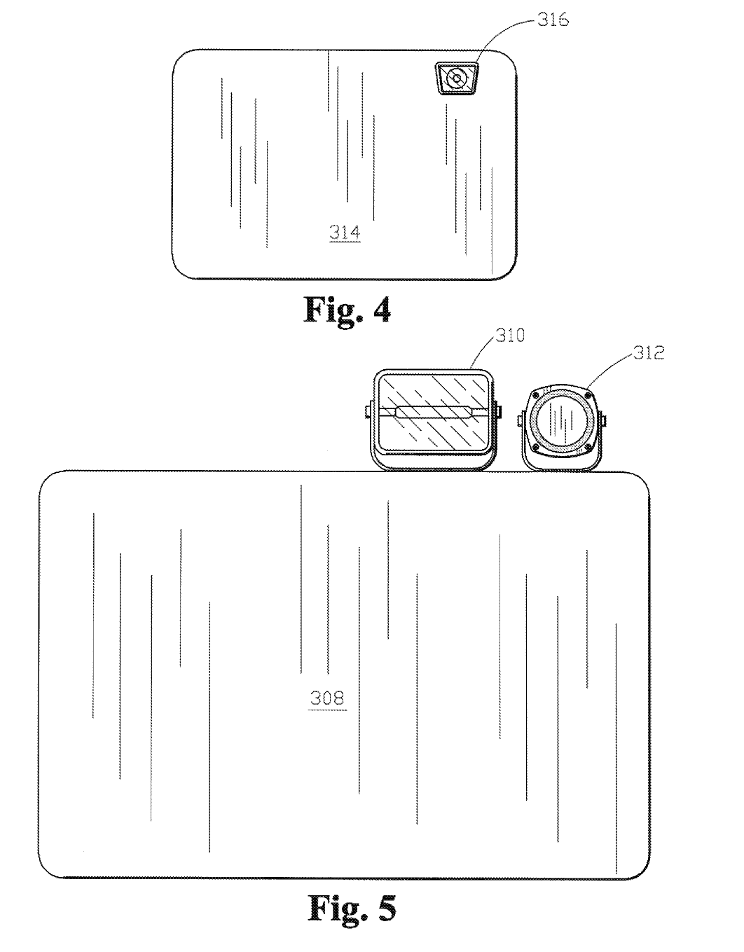

As shown in FIG. 5, a kit 300 of the present invention may further include a sign 308, such as a “For Sale”, “For Rent”, or similar sign to be placed outside of the property. The sign 308 may include a light 310 and/or a siren 312. In these embodiments, the operations may further include activating the light 310 and/or siren 312 in case of emergency. In these embodiments, it will be beneficial to include the processor 202 and machine-readable medium 204 in the unlocking device 104. It is anticipated that the unlocking device 104, such as remote control or key, will be carried by the real estate professional at all times. Accordingly, the user can activate same anytime. On the other hand, it is anticipated that the locking device 102, which is oftentimes bulkier, will be left near the entrance to the property. Moreover, a kit 300 of the present invention may include a name badge 314 as shown in FIG. 4 which includes a second camera 316. In an embodiment including a second camera, the operations may include activating the second camera to begin recording a second feed. The feed from the second camera may also be transmitted to and stored by a storage device as discussed above.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between a network connection of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A system comprising:
a locking device, said locking device configured to allow access to a property;
an unlocking device;
said unlocking device configured to unlock said lockbox to provide access to said property; and
at least one of said locking device and said unlocking device configured to activate at least one safety device.

2. The system of claim 1, wherein said activation of said at least one safety device occurs during an unlocking of said locking device.

3. The system of claim 1, wherein said unlocking device is selected from the group consisting of a remote control, mobile application and a key.

4. The system of claim 1, wherein said at least one safety device is selected from the group consisting of a camera, an audio recorder, a light, a siren, and an apparatus to make an emergency call.

5. An apparatus comprising:
a processor; and
a machine-readable medium storing a set of instruction that, when executed by the processor, cause the processor to execute operations comprising:
unlocking a locking device; and
activating at least one safety device.

6. The apparatus of claim 5, wherein said at least one safety device is selected from the group consisting of a camera, an audio recorder, a light, a siren, and an apparatus to make an emergency call.

7. A kit comprising:
a locking device configured to allow access to a property;
a camera configured to record a feed;
an unlocking device;
a processor;
a machine-readable medium storing a set of instructions that, when executed by the processor, cause the processor to execute operations comprising activating said camera to begin recording said feed.

8. The kit of claim 7, wherein said processor and said machine-readable medium are located in said locking device.

9. The kit of claim 7, wherein said processor and said machine-readable medium are located in said unlocking device and said operations further comprise unlocking said locking device.

10. The kit of claim 7, wherein said operations further comprise activating a light.

11. The kit of claim 7, wherein said operations further comprise activating a siren.

12. The kit of claim 7, wherein said operations further comprise at least one of sending or receiving a global positioning system signal.

13. The kit of claim 7, wherein said operations further comprise sending a panic signal.

14. The kit of claim 13, wherein sending a panic signal further comprises sending a signal to emergency personnel.

15. The kit of claim 14, wherein sending a signal to emergency personnel further comprises dialing 911.

16. The kit of claim 7, further comprising:
a sign comprising a light; and
said operations further comprising activating said light.

17. The kit of claim 7, further comprising:
a sign comprising a siren; and
said operations further comprising activating said siren.

18. The kit of claim 7, further comprising a name badge, wherein said name badge comprises a second camera and said operations further comprise activating said second camera.

19. The kit of claim 7, wherein said feed is stored in a storage device.
